(19) United States
(12) Patent Application Publication
(10) Pub. No.: US 2025/0276735 A1
(43) Pub. Date: Sep. 4, 2025

(54) VEHICLE STRUCTURAL CROSS MEMBER

(71) Applicant: Rivian IP Holdings, LLC, Irvine, CA (US)

(72) Inventors: Jagannathan Shankar Mahadevan, Orange, CA (US); Rafael Teran, JR., Westminster, CA (US); Christopher James Matthews, Huntington Beach, CA (US)

(73) Assignee: Rivian IP Holdings, LLC, Irvine, CA (US)

(21) Appl. No.: 18/594,542

(22) Filed: Mar. 4, 2024

(51) Int. Cl. B62D 21/03; B60R 16/04; B62D 25/20; B62D 27/02

(52) U.S. Cl. CPC B62D 21/03; B60R 16/04; B62D 25/2009; B62D 27/026

(57) ABSTRACT

Apparatuses and methods for a vehicle structural elongated cross member are disclosed. An apparatus can include an elongated cross member. The apparatus can include a structural insert to disposed ins the elongated cross member. The apparatus can include a first sleeve configured to couple with a first end portion of the elongated cross member and to couple with a vehicle. The apparatus can include a second sleeve configured to couple with a second end portion of the elongated cross member and to couple with the vehicle.

### BACKGROUND

Vehicles can include drive systems, power sources, and compartments for operators or passengers of the vehicle. Vehicles can include apparatuses for controlling speed, direction, and stability, to ensure efficient and controlled movement across different terrains or pathways.

### SUMMARY

An aspect of this disclosure is directed to an apparatus. The apparatus can include an elongated cross member. The elongated cross member can be referred to as a cross member. The apparatus can include a structural insert to dispose inside the elongated cross member. The apparatus can include a first sleeve configured to couple with a first end portion of the cross member and to couple with a vehicle. The apparatus can include a second sleeve configured couple with a second end portion of the cross member and to couple with the vehicle.

At least one aspect is directed to a method. The method can include providing an apparatus. The apparatus can include an elongated cross member. In some implementations, the apparatus can include a structural insert to dispose inside the elongated cross member. The apparatus can include a first sleeve configured to couple with a first end portion of the cross member and to couple with a vehicle. The apparatus can include a second sleeve configured couple with a second end portion of the cross member and to couple with the vehicle.

At least one aspect is directed to a vehicle. The vehicle can include an apparatus. The apparatus can include an elongated cross member. In some implementations, the apparatus can include a structural insert to dispose inside the elongated cross member. The apparatus can include a first sleeve configured to couple with a first end portion of the cross member and to couple with the vehicle. The apparatus can include a second sleeve configured couple with a second end portion of the cross member and to couple with the vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example of a vehicle.

FIG. 2 depicts an example of a vehicle apparatus including a cross member.

FIG. 3 depicts an example of a vehicle apparatus including a cross member.

FIG. 4 depicts an example of a structural insert.

FIG. 5 depicts an example of a vehicle apparatus including a cross member with a sleeve.

FIG. 6 depicts an example of an internal frame of a vehicle.

FIG. 7A is a flow diagram illustrating an example method of providing an apparatus including a cross member.

FIG. 7B is a flow diagram illustrating an example method of providing an apparatus including a cross member.

FIG. 8 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of a vehicle structural cross member. The various concepts introduced above and discussed in greater detail below may be implemented in any of numerous ways.

This disclosure is generally directed to an apparatus that can improve weight distribution and mechanical force absorption within a vehicle. Vehicles can be subjected to a range of forces during vehicle operations. For example, the magnitude of the forces can increase on paved streets or off-road bumpy terrains. The apparatuses, systems, devices, and methods described herein can include an elongated cross member or other structural element that can direct force to, or divert force from, certain elements of the vehicle.

The technical solution described herein can include an apparatus. The apparatus can include an elongated cross member. The apparatus can include a structural insert to dispose inside the elongated cross member. The apparatus can include a first sleeve configured to couple with a first end portion of the cross member and to couple with the vehicle. The apparatus can include a second sleeve configured couple with a second end portion of the cross member and to couple with the vehicle.

The apparatus can be applied in various types of vehicles. The apparatus can support structural components of a vehicle such as battery packs, chassis support structures, and specially designed apparatuses. The seat cross member, often a standard component without such design variations, can be optimized through this innovation. The strategic positioning of a structural insert along specific areas of the cross member's length can enhance robustness. This innovation can improve the structural rigidity of the cross member and can achieves a superior strength-to-weight ratio. The apparatus can enhance the vehicle performance and efficiency by reducing excess material and weight.

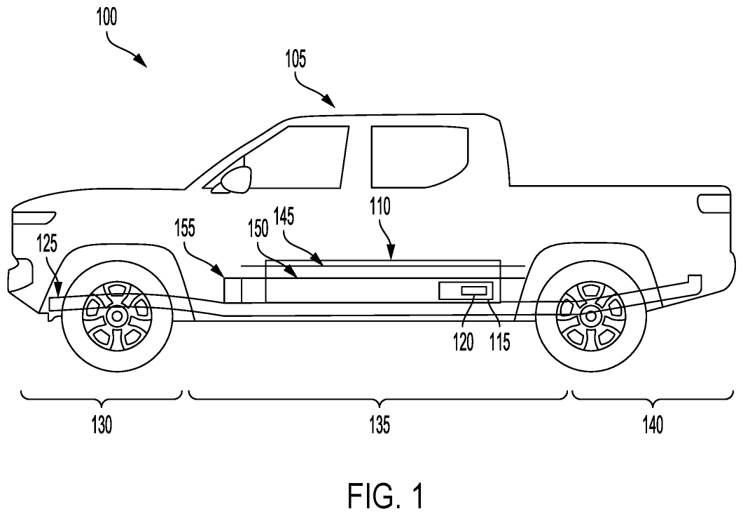

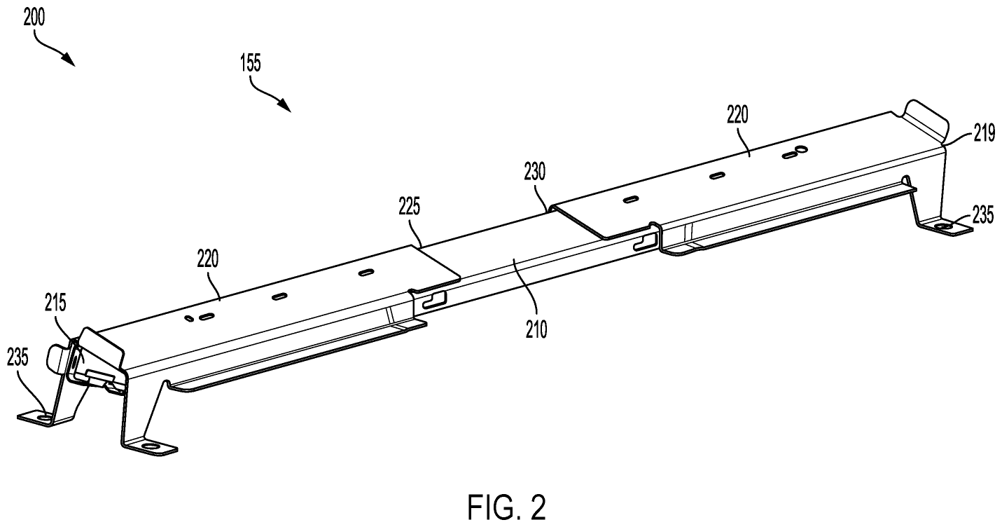

FIG. 1 depicts an example cross-sectional view 100 of a vehicle 105 installed with at least one battery pack 110. Vehicles 105 can include trucks, sport utility vehicles (SUVs), delivery vans, automobiles, cars, passenger vehicles, passenger or commercial trucks, hybrid vehicles, electric vehicles, or other vehicles such as sea or air transport vehicles, planes, helicopters, submarines, boats, or drones, among other possibilities. The battery pack 110 can also be used as an energy storage system to power a building, such as a residential home or commercial building. Vehicles 105 can be fully autonomous, partially autonomous, or unmanned. Vehicles 105 can also be human operated or non-autonomous. Vehicles 105 such as trucks or automobiles can include on-board battery packs 110, batteries 115 or battery modules 115, or battery cells 120 to power the vehicles. The vehicle 105 can include a chassis 125 (e.g., a frame, internal frame, or support structure). The chassis 125 can support various components of the vehicle 105. The chassis 125 can span a front portion 130 (e.g., a hood or bonnet portion), a body portion 135, and a rear portion 140 (e.g., a trunk, payload, or boot portion) of the vehicle 105. The battery pack 110 can be installed or placed within the vehicle 105. For example, the battery pack 110 can be installed on the chassis 125 of the vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the vehicle 105 to provide electrical power to various systems or components of the vehicle 105. The vehicle 105 can include an apparatus 155 (the apparatus is discussed in detailed in FIG. 2).

FIG. 2 depicts an example view 200 of the apparatus 155. The apparatus 155 can include a cross member 210, a structural insert 215, a first sleeve 220, and a second sleeve 220. The apparatus 155 can connect to different parts of the vehicle 105 frame. The apparatus 155 can have a beam-like structure. The apparatus 155 can provide structural support to the chassis 125 or body portion 135 of the vehicle 105. The apparatus 155 can evenly distribute the weight of the vehicle 105. The distribution of weight can provide stability for the vehicle 105 when the vehicle 105 is in motion. The apparatus 155 can absorb and distribute the mechanical forces exhibited on or by the vehicle 105. The apparatus 155 can provide support to the vehicle 105 suspension system by reducing vibrations and harshness transmitted from the road.

The cross member 210 can be an elongated cross member. The cross member 210 can be made of steel, aluminum, or composite materials (e.g., carbon fiber). The shape of the cross member 210 can be a beam-like structure. The shape of the cross member 210 can include rectangular, tubular, or custom-formed beams. The cross member 210 can include crumple zones or deformations to absorb impact forces exhibited on the vehicle 105. The mass of the cross member 210 can contribute to the balance and weight distribution of the vehicle 105. When the mass distribution of the cross member 210 is optimized, the weight distribution can be improved without increasing the total weight of the vehicle. The cross member 210 can have a length of 30 inches, 40 inches, 50 inches, 60 inches, 70 inches, or any value in between. The length of the cross member 210 can be less than 30 inches or greater than 70 inches.

The apparatus 155 can have one or more structural inserts 215. The apparatus 155 can have 2, 3, 4, or more structural inserts 215. The structural inserts 215 can dispose inside the cross member 210. The structural inserts 215 can increase the rigidity and strength of the cross member 210. The structural inserts 215 can serve as a reinforcement and resist twisting and bending forces exhibited on the cross member 210. The structural inserts 215 can reduce vibrations and noise transmitted through the chassis 125. The structural inserts 215 can absorb impact forces. The structural inserts 215 can be used to adjust the weight distribution of the vehicle 105. The structural inserts 215 can be composed of steel alloys, aluminum alloys, carbon fiber, fiberglass, polyethylene, polyurethane, elastomeric materials, rubber, or a combination of those and of different materials. A first structural insert 215 can be disposed at a first end 217 of the cross member 210. A second structural insert 215 can be disposed at a second end 219 of the elongated cross member.

The first sleeve 220 and the second sleeve 220 can include a rectangular, tubular, or cylindrical component that can fit over or around a part of the cross member 210. The first sleeve 220 and the second sleeve 220 can include a connection or joint, to provide additional strength, stability, or alignment to the connected parts. The first sleeve 220 and the second sleeve 220 can couple with the cross member 210 by a press fit, welding, bolting, use of adhesives, or other mechanical fastening methods. The first sleeve 220 and the second sleeve 220 can provide mechanical support to the cross member 210. The first sleeve 220 and the second sleeve 220 can be composed of steel, aluminum, carbon fiber, fiberglass, high-strength plastics, or a combination of those and of different materials.

The first sleeve 220 can couple with a first end portion 225 of the cross member 210. The second sleeve 220 can couple with a second end portion 230 of the cross member 210. The first sleeve 220 and the second sleeve 220 can use similar or different methods of coupling. The first sleeve 220 and the second sleeve 220 can distribute the loads more evenly across the cross member 210, reduce stress concentrations, and provide attachment points for other vehicle 105 components like the suspension, exhaust, or drivetrain components.

The first sleeve 220 can couple with the vehicle 105. The first sleeve 220 can couple with the vehicle 105 at the floor of the vehicle. The second sleeve 220 can couple with the vehicle 105. The first sleeve 220 and the second sleeve 220 can couple with the vehicle through a floor engagement feature to secure the apparatus 155 to the floor of the vehicle 105. The first sleeve 220 and the second sleeve 220 can have pre-drilled holes 235 that align with corresponding holes in the floor of the vehicle. Bolts can pass through the holes 235, and nuts can be used to secure the sleeve in place. The first sleeve 220 and the second sleeve 220 can be attached to the floor of the vehicle using rivets. The first sleeve 220 and the second sleeve 220 can be welded directly to the floor of the vehicle. The apparatus 155 can be positioned underneath a seat of the vehicle 105. The apparatus 155 can allow access for vehicle maintenance.

The first sleeve 220 or the second sleeve 220 can attach to a door frame of the vehicle 105. The first sleeve 220 or the second sleeve 220 can serve as a mounting point for the door frame of the vehicle 105. The apparatus 155, via the first sleeve 220 or the second sleeve 220 can transfer and distribute the impact forces away from the door frame of the vehicle 105. The apparatus 155 can reinforce the door frame of the vehicle 105 by providing additional strength at points hinges or locking mechanisms of the door frame are attached. The apparatus 155 can provide a protected pathway for wiring (such as power windows, locks, and speakers wiring) that run through the door frame of the vehicle 105.

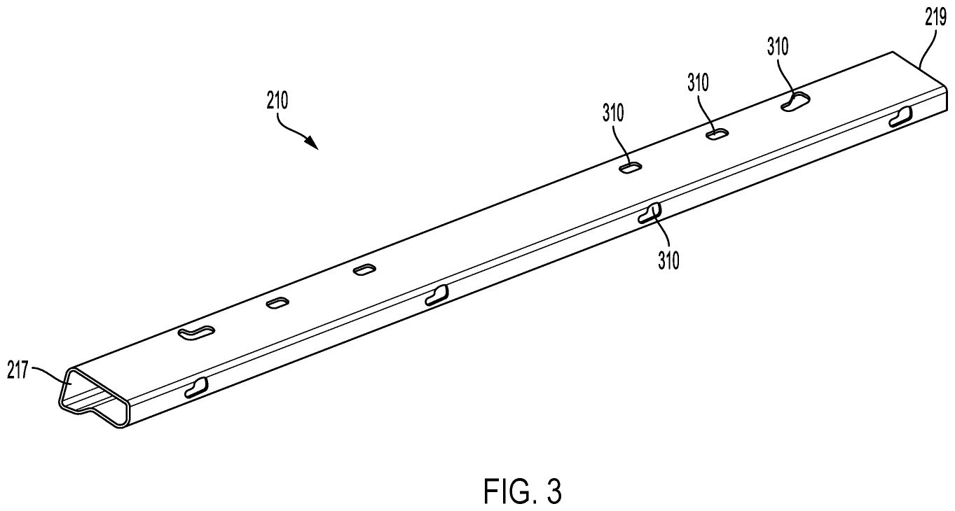

FIG. 3 depicts cross member 210. The ends 217 and 219 of the cross member 210 can have flanges that provide a surface for the sleeves 220 (FIG. 2) to sit against. The flanges can provide interfaces with other structural components of the vehicle 105. The ends 217 and 219 of the cross member 210 can include notches, slots, or interlocking mechanisms to fit with the sleeves 220 or other vehicle 105 components. The ends 217 and 219 of the cross member 210 can be reinforced by thickening the material or adding additional layers or structures, to support the weight and stress concentrations at points of contact.

The cross member 210 can have holes 310 along its length. The cross member 210 can have holes 310 along its sides. The holes 310 can have different shapes and dimensions. The placement of the 310 holes can align with the structural inserts 215 within the cross member 210. The holes 310 can reduce the mass of the cross member 210 without compromising its structural integrity. The holes 310 can be used as attachment points for fasteners like bolts, screws, or rivets when securing the cross member to the sleeves or other parts of the vehicle 105. The holes 310 can provide access for running cables, pipes, or for the use of tools during assembly or maintenance. The holes 310 can allow the use of inspection tools (e.g., during maintenance) without disassembling the apparatus 155 component. The holes 310 can provide access to route brake lines, fuel lines, or exhaust components.

The holes 310 can provide access for routing high-voltage cables or cooling lines for the battery packs 110. The cross member 210 can couple with the battery pack 110. The cross member 210 can couple with the battery pack 110 via mounting points (e.g. fastening system through holes 310) along the length of the cross member 210, a reinforced area where the battery pack 110 can attach, or a mounting bracket or frame.

The first sleeve 220 or the second sleeve 220 can be coupled to or inserted into the cross member 210 to provide structural support for the battery pack 110. The first sleeve 220 or the second sleeve 220 can strengthen the area where the battery pack 110 is located. The first sleeve 220 or the second sleeve 220 can provide reinforcement to the cross member and can distribute the weight of the battery pack 110 across the cross member 210. The first sleeve 220 or the second sleeve 220 can provide mounting points for systems that can maintain the battery pack 110 (e.g., thermal management system or cooling system).

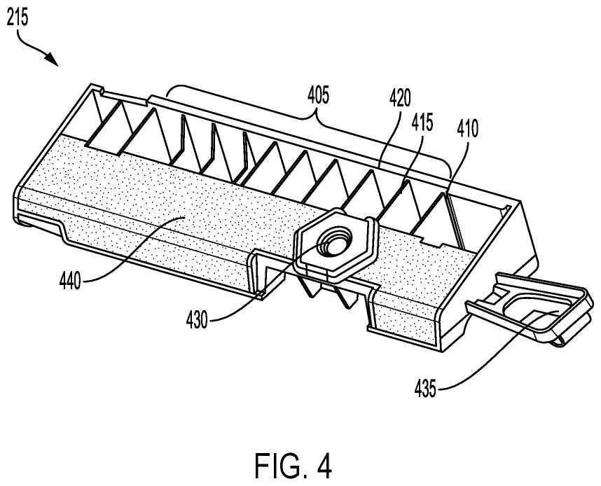

FIG. 4 depicts structural inserts 215. The structural inserts 215 can dampen vibrations. The structural inserts 215 can have multiple ribs 405 across its length. The ribs 405 can have a rectangular, triangular, or trapezoidal cross-section. The ribs 405 can provide strength and rigidity to the structural inserts 215. The ribs 405 can be arranged in a manner where the spacing between the ribs 405 is not uniform. The structural inserts 215 can include a first rib 410, a second rib 415, and a third rib 420. In the example shown in FIG. 4, distance between the first rib 410 and the second rib 415 is greater than the distance between the second rib 415 and the third rib 420. The greater space between the first rib 410 and second rib 415 can allow for more flexibility or compression under load. The closer spacing between the second rib 415 and third rib 420 can include a region of increased stiffness.

The structural inserts 215 can include a bolt hole 430. The bolt hole 430 can be made of nylon. The bolt hole 430 can have a hexagonal recess. The bolt hole 430 can fasten the structural insert 215 with the apparatus 155 components or other vehicle 105 components. The bolt hole 430 can allow for precise alignment of the structural inserts 215 during assembly. When a bolt is inserted and tightened, the bolt hole 430 can apply a clamping force on the structural insert 215 and on the apparatus 155 components. The clamping force can hold the structural insert 215 and the apparatus 155 components together. The bolt hole 430 can serve as a mounting point for accessories or additional components to be added to the structural inserts 215. The bolt hole 430 can secure the structural insert 215 to allow the structural insert 215 to absorb and dissipate vibrational energy. The structural inserts 215 can include a tab 435. The tab 435 can protrude at an end of the structural insert 215. The tab 435 can be used as a mounting point to allow the structural insert 215 to be attached to other components. The tab 435 can be a point of interaction or access during vehicle 105 service or maintenance.

The structural inserts 215 can include an adhesive 440. The adhesive 440 can be a structural adhesive. The adhesive 440 can include epoxy adhesives, modified epoxy adhesives, acrylic adhesives, urethane adhesives, cyanoacrylate adhesives, silicone adhesives, and methacrylate adhesives. The adhesive 440 can bond components securely, distribute loads across joints, and maintain bond strength under various environmental conditions. The adhesive 440 can distribute stresses over a larger surface area, which can reduce stress concentrations. The adhesive 440 can reduce the number of fasteners, bolts, rivets, and welds required within the structural insert 215.

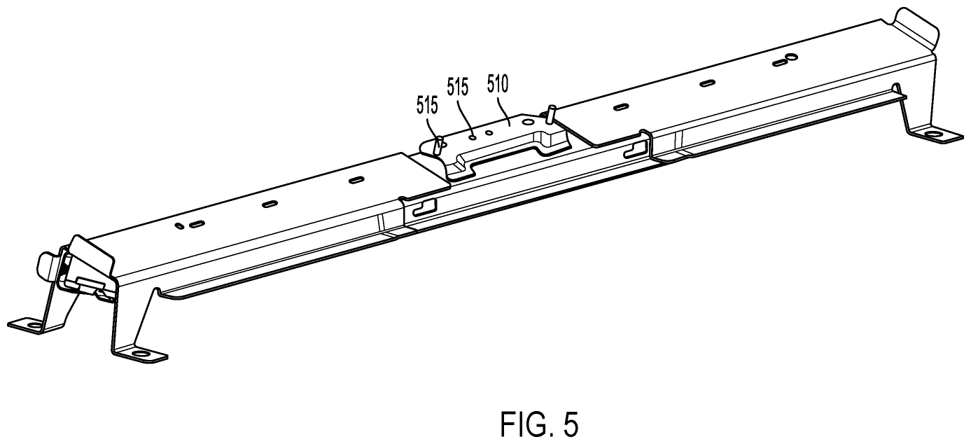

FIG. 5 depicts an apparatus with a third sleeve. The third sleeve 510 can fit over or around a part of the cross member 210 to provide strength, stability, or alignment to the cross member 210. The third sleeve 510 can include one or more attachment points 515 for other vehicle components, such as suspension, exhaust, or drivetrain components. The attachment points 515 can include holes, bolts, screws, nuts, rivets, screw threads, or weld points. The third sleeve 510 can reinforce the structure at the attachment point 515 where additional strength can be needed. The third sleeve 510 can have a similar or different design than the first sleeve 220 and the second sleeve 220. The third sleeve 510 can have a similar design, with a cylindrical, rectangular, or custom-shaped profile that matches the design of the cross member 210.

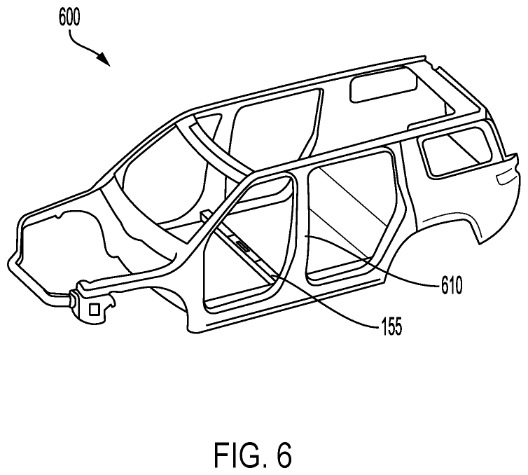

FIG. 6 depicts an internal frame 600 of a vehicle. The internal frame 600 of the vehicle can include the apparatus 155. The apparatus 155 can be located in areas that require additional support or where the vehicle is subject to higher stresses. The apparatus 155 can be positioned along a lateral axis of the vehicle to contribute to the torsional rigidity of the vehicle. The apparatus 155 can be positioned under a seat of the vehicle. The apparatus 155 can provide a mounting point for the seat attachments. The apparatus 155 can be connected to a doorframe 605.

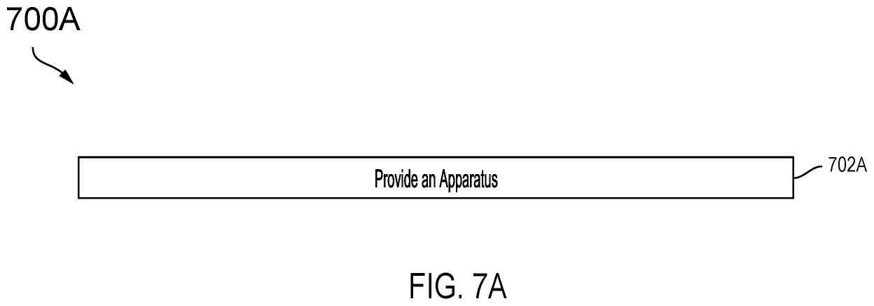

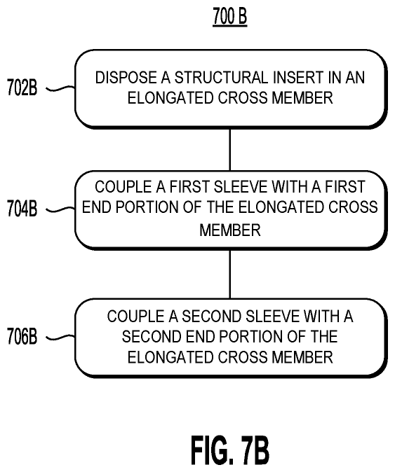

FIG. 7A depicts a method 700A for providing an apparatus. The method 700A can include providing the apparatus at ACT 702A. The apparatus can include an elongated cross member. The apparatus can include a structural insert to dispose in the elongated cross member. The apparatus can include a first sleeve configured to couple with a first end portion of the cross member and to couple with a vehicle. The apparatus can include a second sleeve configured couple with a second end portion of the cross member and to couple with the vehicle.

FIG. 7B depicts a method 700B for providing an apparatus. The method 700B can be implemented using any one or more of the components and devices detailed herein in conjunction with FIGS. 1-6. The method 700B can include disposing a structural insert in an elongated cross member at ACT 702B. The method 700B can include coupling a first sleeve with a first end portion of the elongated cross member at ACT 704B. The first sleeve can be configured to couple with a vehicle. The method 700B can include coupling a second sleeve with a second end portion of the elongated cross member at ACT 706B. The second sleeve can be configured to couple with the vehicle.

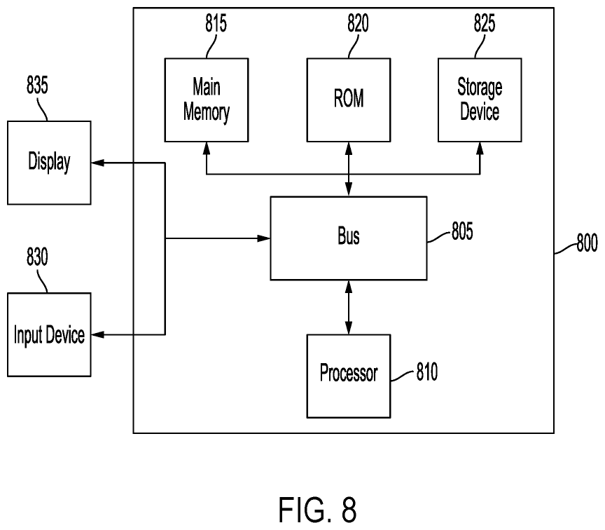

FIG. 8 depicts an example block diagram of an example computer system 800. The computer system or computing device 800 can include or be used to implement a data processing system or its components. The computing system 800 includes at least one bus 805 or other communication component for communicating information and at least one processor 810 or processing circuit coupled to the bus 805 for processing information. The computing system 800 can also include one or more processors 810 or processing circuits coupled to the bus for processing information. The computing system 800 also includes at least one main memory 815, such as a random-access memory (RAM) or other dynamic storage device, coupled to the bus 805 for storing information, and instructions to be executed by the processor 810. The main memory 815 can be used for storing information during execution of instructions by the processor 810. The computing system 800 may further include at least one read only memory (ROM) 820 or other static storage device coupled to the bus 805 for storing static information and instructions for the processor 810. A storage device 825, such as a solid-state device, magnetic disk or optical disk, can be coupled to the bus 805 to persistently store information and instructions.

The computing system 800 may be coupled via the bus 805 to a display 835, such as a liquid crystal display, or active-matrix display, for displaying information to a user such as a driver of the electric vehicle 705 or other end user. An input device 830, such as a keyboard or voice interface may be coupled to the bus 805 for communicating information and commands to the processor 810. The input device 830 can include a touch screen display 835. The input device 830 can also include a cursor control, such as a mouse, a trackball, or cursor direction keys, for communicating direction information and command selections to the processor 810 and for controlling cursor movement on the display 835.

The processes, systems and methods described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. Hard-wired circuitry can be used in place of or in combination with software instructions together with the systems and methods described herein. Systems and methods described herein are not limited to any specific combination of hardware circuitry and software.

Although an example computing system has been described in FIG. 8, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
an elongated cross member;
a structural insert disposed in the elongated cross member;
a first sleeve coupled with a first end portion of the elongated cross member and configured to couple with a vehicle; and
a second sleeve coupled with a second end portion of the elongated cross member and configured to couple with the vehicle.

2. The apparatus of claim 1, wherein the structural insert is a first structural insert, comprising:
the first structural insert disposed at a first end of the elongated cross member; and
a second structural insert disposed at a second end of the elongated cross member.

3. The apparatus of claim 1, comprising:
the structural insert comprising a plurality of ribs.

4. The apparatus of claim 1, comprising:
the structural insert comprising a first rib, a second rib, and a third rib, wherein a distance between the first rib and the second rib is greater than the distance between the second rib and the third rib.

5. The apparatus of claim 1, comprising:
the structural insert comprising an adhesive.

6. The apparatus of claim 1, wherein:
the elongated cross member is configured to couple with a battery pack.

7. The apparatus of claim 1, comprising:
a floor engagement feature to secure the apparatus to the floor of the vehicle.

8. The apparatus of claim 1, wherein:
the apparatus is configured to be positioned underneath a seat of the vehicle.

9. The apparatus of claim 1, wherein:
the first sleeve or the second sleeve is configured to attach to a door frame of the vehicle.

10. The apparatus of claim 1, comprising:
a third sleeve coupled with the elongated cross member and configured to couple with a vehicle, wherein the third sleeve provides an attachment point between the apparatus and the vehicle.

11. A method, comprising:
disposing a structural insert in an elongated cross member;
coupling a first sleeve with a first end portion of the elongated cross member, the first sleeve configured to couple with a vehicle; and
coupling a second sleeve with a second end portion of the elongated cross member, the second sleeve configured to couple with the vehicle.

12. The method of claim 11, comprising:
the structural insert comprising a plurality of ribs.

13. The method of claim 11, comprising:
inserting at least one of the first sleeve or the second sleeve into the elongated cross member.

14. The method of claim 11, comprising:
coupling the elongated cross member with a battery pack.

15. The method of claim 11, comprising:
attaching at least one of the first sleeve or the second sleeve to a door frame of the vehicle.

16. The method of claim 11, comprising:
coupling a third sleeve with the elongated cross member, the third sleeve including an attachment point between an apparatus and the vehicle.

17. A vehicle, comprising:
an apparatus, the apparatus comprising:
an elongated cross member;
a structural insert disposed in the elongated cross member;
a first sleeve coupled with a first end portion of the elongated cross member and configured to couple with the vehicle; and
a second sleeve coupled with a second end portion of the elongated cross member and configured to couple with the vehicle.

18. The vehicle of claim 17, wherein the structural insert is a first structural insert, comprising:
the first structural insert disposed at a first end of the elongated cross member; and
a second structural insert disposed at a second end of the elongated cross member.

19. The vehicle of claim 17, comprising:
the structural insert comprising a plurality of ribs.

20. The vehicle of claim 17, comprising:
the structural insert comprising a first rib, a second rib, and a third rib, wherein a distance between the first rib and the second rib is greater than the distance between the second rib and the third rib.
